(19) United States
(12) Patent Application Publication
(10) Pub. No.: US 2007/0264529 A1
(43) Pub. Date: Nov. 15, 2007

(54) Ceramic Laminate

(76) Inventors: Thomas Wahl, Pforzheim (DE); Lothar Diehl, Gerlingen (DE); Stefan Rodewald, Ditzingen (DE); Frank Buchholz, Neckartenzlingen (DE)

Correspondence Address: KENYON & KENYON LLP, ONE BROADWAY, NEW YORK, NY, 10004, US

(21) Appl. No.: 10/581,783

(22) PCT Filed: Dec. 3, 2004
(86) PCT No.: PCT/EP04/53254

§ 371 Date: Mar. 29, 2007

(30) Foreign Application Priority Data
Dec. 18, 2003 (DE) 103 59 569.4

(51) Int. Cl. G11B 5/33

(52) U.S. Cl. 428/814

(57) ABSTRACT

A ceramic laminate is provided which has at least one solid electrolyte layer, an electrical resistor track embedded in an insulation, and especially running in a meandering shape, and two electrical lead tracks to the resistor track. To reduce the danger of crack formation in the insulation, the resistor track is made up of a material having a greater specific Ohmic resistance compared to the material of the lead tracks and has as great a track width as possible at a low track thickness.

### FIELD OF THE INVENTION

The present invention relates to a ceramic laminate having at least one solid electrolyte layer.

### BACKGROUND INFORMATION

A ceramic laminate is used as a heating device in sensor elements for electrochemical sensors, such as for lambda probes for measuring the oxygen concentration in the exhaust gas of internal combustion engines, or as a temperature sensor for determining the temperature of a medium, especially the exhaust gas of internal combustion engines. The layer buildup is obtained, for instance, by foil casting, silk-screening, laminating and sintering.

In one known sensor element for a lambda probe described in published German Patent document DE 198 34 276, altogether three solid electrolyte layers are present, and the resistor track with its two lead tracks is embedded between two insulating layers which each cover one solid electrolyte layer, a sealing frame being applied all around the insulating layers, which is made of the same material as the solid electrolyte layers. Whereas the lower solid electrolyte layer is used as the substrate, on which the lower insulating layer lies, a reference gas channel is recessed into the solid electrolyte layer that covers the upper insulating layer. Onto this solid electrolyte layer, the third solid electrolyte layer is set, which on its upper side carries an outer measuring electrode or Nernst electrode covered by a protective layer, and on its lower side carries an inner measuring electrode or reference electrode in the vicinity of the reference gas channel. The solid electrolyte layers include essentially zirconium oxide (ZrO₂), and the insulating layers include aluminum oxide (Al₂O₃). After the application of the layers, e.g., using the silk-screening method or by laminating of cast foils, the sensor element is sintered at a temperature such as 1300-1600°.

As a result of different thermal coefficients of expansion of the materials used for the solid electrolyte layers and the insulating layers, after a stress-free state has set in during sintering, compressive stresses are created during cooling of the sensor element, on the inside of the insulating layers. The resistor track embedded in the insulating layers also lies free in an insulating channel that forms in the insulating layers, since the thermal coefficient of expansion of the material of the resistor track, just as the thermal coefficient of expansion of the material of the solid electrolyte layers, is greater than the thermal coefficient of expansion of the material of the insulating layers. At sufficiently slow cooling rate, the stress-free state prevailing at the sintering temperature is still maintained down to a temperature that is far below the sintering temperature, the so-called inversion temperature. The compressive stresses then set in upon further cooling. If the inversion temperature is exceeded in the operation of a sensor element, the stress relationships reverse, and the insulating layers now experience tensile stress because the solid electrolyte layer and the resistor track expand more greatly. Because of these tensile stresses, cracks occur in the insulating layers, which spread out transversely to the longitudinal direction of the insulating layers, and lead to the destruction of the sensor element as soon as they cut through the insulating layers and the solid electrolyte layers, and exhaust gas enters into the reference gas channel. Because of the low critical tensile stress of the material of the insulating layers, even small tensile stresses may trigger cracks.

In order to increase the service life of the sensor elements, pore-forming materials are conventionally added to the aluminum oxide-containing material of the insulating layers, before sintering. By this deliberate introduction of a porosity into the material of the insulating layers, the elasticity of the insulating layers is increased, and the compressive and tensile stresses are reduced thereby. However, the reduction in material stresses occurs mainly on the inside of the insulating layers, and the reduction decreases towards the boundary surfaces of the insulating layers, since in this location an open surface is present into which the cracks are well able to enter. Such boundary surfaces appear particularly in the direction towards the resistor track, where the material of the insulating layers has formed the insulating channel filled by the resistor track.

In one known temperature sensor for determining the temperature of a medium, e.g., the exhaust gas of internal combustion engines, as described in published German patent document DE 100 45 940, the laminate has a substrate made of a ceramic oxide material, such as yttrium-stabilized zirconium oxide, two insulating layers made, for instance, of aluminum oxide which enclose between them the electrical resistor track having two electrical lead tracks, and of which the one is applied to the substrate, and a cover layer that covers the other insulating layer that faces away from the substrate, that is made of the same material as the substrate. The resister track is developed in a meandering shape, while the two lead tracks run parallel to each other. The resistor track which forms the measuring range of the temperature sensor has a greater electrical resistance than the two lead tracks. This is attained by a variation of the material composition in the resistor track, on the one hand, and in the lead tracks, on the other hand. All the tracks are made of platinum pastes, which contain platinum and aluminum oxide as well as a binder. Because of different percentage proportions of platinum and aluminum oxide, the specific Ohmic resistance of the material is manipulated for the resistor track and the lead track. The resistor track and the lead tracks are produced by printing of the platinum paste onto the one insulating layer.

### SUMMARY

The ceramic laminate according to the present invention has the advantage that, because of the great width of the resistor track, the maximum width of which is only limited by the width of the laminate, the susceptibility of the insulation to form cracks is reduced. This is conditioned, on the one hand, by the wider resistor track giving off heat to the insulation over a greater surface, and therefore being less overheated in response to rapid heating. On the other hand, in the wide resistor track, defects created by silk-screening lead much less rapidly to narrow spots in the resistor track than in the case of a narrow resistor track. Because of that, no local hot spots, or at least substantially fewer hot spots, occur, which trigger the cracking mechanism described at the outset. If, for example, the width of the resistor track is made to be greater than 500 μm, the ratio to the lateral fluctuations of the silk-screening is less than 5%. Because of that, the resistor fluctuations which trigger the hot spots are less than 5%. In addition, fluctuations in the track thickness of the resistor track created by height fluctuations in the insulating layer average out better, because of the greater width of the resistor track, since the ratio of width to cross section of the resistor track is rather high, according to the present invention, for instance, greater than 1/14 μm. Because of the differently sized specific Ohmic resistance of the materials used for the lead track, on the one hand, and the resistor track, on the other hand, for instance, platinum or platinum alloys having different proportions of aluminum oxide or alloy components, the resistance ratio between the resistor track and the lead tracks is held in a favorable manner with regard to the concentration of the heating performance in the resistor track.

According to one advantageous example embodiment of the present invention, the specific Ohmic resistance of the material of the resistor track is selected to be at least twice as great as the specific Ohmic resistance of the material of the lead tracks. In this context, the temperature coefficient of the material of the resistor track is less than the temperature coefficient of the material of the lead tracks. P According to one advantageous example embodiment of the present invention, the width of the resistor track is greater than that of a lead track, e.g., the width of the resistor track being 50% greater than the width of a lead track.

According to another example embodiment of the present invention, the insulation in which the resistor track is embedded is made of a first insulating layer applied to the one solid electrolyte layer, on which at least the resistor track is printed, and a second insulating layer that covers at least the resister track. The two insulating layers may also cover the circuit board conductors. The insulating layers may be made of aluminum oxide (Al₂O₃).

### BRIEF DESCRIPTION OF THE DRAWINGS

FIG. 1 shows a cross-section of a sensor element for a λ=1 probe, taken along the line I-I shown in FIG. 2.

FIG. 2 shows a longitudinal section of the sensor element, taken along line II-II shown in FIG. 1.

FIGS. 3 and 4 show longitudinal sections of additional exemplary embodiments of the sensor element according to the present invention.

### DETAILED DESCRIPTION

The sensor element, shown in cross-section in FIG. 1, for a voltage-jump sensor or a λ=1 sensor for measuring the oxygen concentration in the exhaust gas of internal combustion engines, has a laminate 10, whose individual layers, lying one over the other, are made by sealing layer processes, such as foil casting and/or by silk-screening. A lower first solid electrolyte layer 11 is used as substrate for the construction of laminate 10, while an upper second solid electrolyte layer 12, on its upper side, carries an outer measuring electrode or Nernst electrode 14, and on its lower side, carries an inner measuring electrode or reference electrode 15. An electrical heater 16 is situated on first solid electrolyte layer 11, and between electrical heater 16 and second solid electrolyte layer 12 lies a third solid electrolyte layer 13, in which a reference gas channel 17 is recessed, in the region of reference electrode 15, which is in contact with a reference gas, e.g., air. Nernst electrode 14 is covered by a porous protective layer 18 that coats the surface of second solid electrolyte 12. All solid electrolyte layers 11 through 13 are made of yttrium-stabilized zirconium oxide (ZrO₂).

Electric heater 16 includes an electrical resistor track 20 embedded in an insulation, and two lead tracks 24 and 25 to resistor track 20. The insulation is made of a lower insulating layer 21 which lies on first solid electrolyte layer 11 and an upper insulating layer 22 which lies against solid electrolyte layer 13. Insulating layers 21, 22 are made essentially of aluminum oxide (Al₂O₃), and may contain additives. Both insulating layers 21, 22 are fastened to the respectively assigned solid electrolyte layer 11 and 13, for instance, by a foil adhesive or by being printed on. The two insulating layers 21, 22 are surrounded by a sealing frame 23, which is made of zirconium oxide, just as are solid electrolyte layers 11-13.

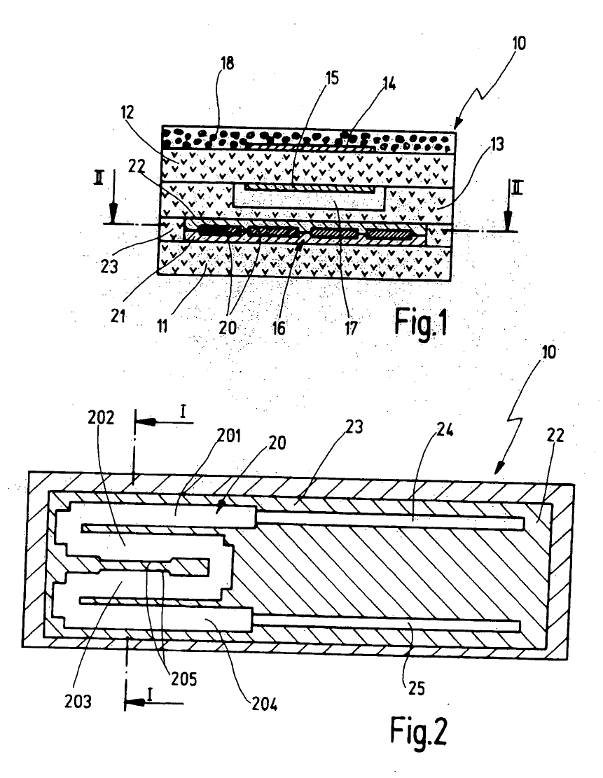

As may be recognized from the sectional representation according to FIG. 2, resistor track 20 is connected in one piece to the two circuit board conductors 24, 25 that run parallel to each other, which are also embedded in the two insulating layers 21, 22. Each printed circuit conductor 24, 25 is contacted at its end facing away from electrical resistor track 20 to a contact surface printed onto the free surface of first solid electrolyte layer 11, passing through first solid electrolyte layer 11. Via the two contact surfaces, electrical resistor track 20 is able to be connected to a current source, such as the vehicle electrical system. Electrical resistor track 20, just as circuit board conductors 24, 25 and the contact surfaces having through-hole plating, are made of platinum or a platinum cermet. After the production of laminate 10, it is sintered at a temperature of approximately 1300-1600° C. and cooled thereafter.

The aluminum oxide of insulating layers 21, 22, the zirconium oxide of solid electrolyte layer 11, 13 (surrounding insulating layers 21, 22) and of sealing frame 23, and the platinum of electrical resistor track 20, have quite different thermal coefficients of expansion, the thermal coefficients of expansion of the zirconium oxide and of the platinum being greater than the thermal coefficient of expansion of the aluminum oxide. During sintering, a stress-free state sets in, which results in response to sufficiently slow cooling down to a certain temperature below the sintering temperature. Upon further cooling below the so-called inversion temperature, compressive stresses are created on the inside of insulating layers 21, 22. If the sensor element is rapidly heated beyond the inversion temperature during operation, the stress ratios in laminate 10 reverse, so that the aluminum oxide of insulating layers 21, 22 is now subjected to a tensile stress by the zirconium and the platinum. The maximum tensile stress component, in this context, is greatest along the longitudinal extension of laminate 10. Because of the tensile stresses, cracks form in the aluminum oxide, which spread perpendicular to the greatest tensile stress, that is, in the transverse plane of laminate 10, and may lead to the destruction of the sensor element.

In order to minimize the danger of triggering cracks, the following measures are taken in accordance with the present invention:

In a first printing step, the two lead tracks 24, 25 are printed onto insulating layer 21, using a material having a small specific Ohmic resistance. For this, a platinum paste containing an aluminum oxide support, e.g., of 5%, is used. In the second printing step, resistor track 20 is printed onto lower insulating layer 21 in a meandering shape, using a material having a substantially greater specific Ohmic resistance. The specific Ohmic resistance of the material for resistor track 20 is selected, in this instance, to be at least twice as great as that of the material for lead tracks 24, 25, and the temperature coefficient of the material of resistor track 20 is less than that of the material of lead tracks 24, 25. Here too, a platinum paste is used which, however, contains an aluminum support of, for example, 30%. In this context, resistor track 20 obtains quite a great width, which is selected to be as big as possible with respect to the available width of insulating layer 21. The width of resistor track 20 is greater than the width of lead tracks 24, 25, and is selected to be at least 50% greater. For example, the width of resistor track 20 is dimensioned at 560 μm, or around 1000 μm.

In the exemplary embodiment of FIG. 2, resistor track 20 is printed onto lower insulating layer 21 in three meandering windings, having altogether four parallel meander legs 201-204. The inner meander legs 202, 203, that face each other each have a local widening in their track widths. The thickness in which resistor track 20 and lead tracks 24, 25 are printed on may be equal and is selected at less than 14 μm, for example. In this context, the minimum thickness of resistor track 20 is specified at approximately 5 μm because of the cohesion of the platinum grains. The maximum width of the resistor track 20 is limited by the width which is specified by lower insulating layer 21, and in addition, interstices between meander legs 201-204 have to be taken into consideration. These interstices are also minimized.

Because of the extreme width of resistor track 20, defects in resistor track 20, which are created by the printing of resistor track 20, in contrast to narrow resistor tracks, do not lead to narrow spots, which effect local overheating as a result of their great resistance, and thereby trigger the above-described crack mechanism in insulating layers 21, 22 made of aluminum oxide. Also, because of the great width of resistor track 20, the ratio of width to cross section is rather large, e.g., in the above exemplary embodiment it is greater than 1/14 μm, so that fluctuations in the thickness of resistor track 20 extensively average out, based on height fluctuations of lower insulating layer 21, because of the great width of resistor track 20.

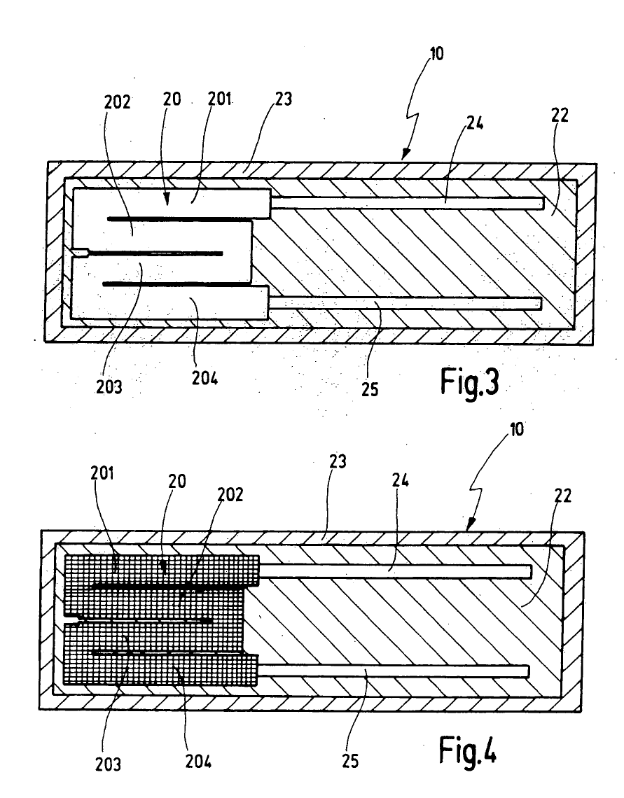

In the exemplary embodiment of FIG. 3, an extremely wide resistor track 20 is printed onto lower insulating layer 21. In the platinum paste for resistor track 20, extremely fine platinum grains are used, having a grain diameter of 200 nm to 1 μm. Such fine-grained platinum is called nanoplatinum. The nanoplatinum is applied in a scantly filled paste, having a proportion of 50%, and after the removal of the binder, the extremely thin resistor track 20 is obtained at a track thickness of less than 5 μm.

In the exemplary embodiment of FIG. 4, the three meandering windings of resistor track 20 are printed having the four meander legs 201-204 as a net. Because of this, the number of edges that are subjected to spread in the silk-screening is substantially increased, and the resistance fluctuations over the course of resistor track 20 largely average out. Overall, there is created a resistor track 20 having an almost constant resistance over the length of the track, and local resistance fluctuations, which lead to hot spots, are eliminated.

The laminate according to the present invention, having resistor track 20 embedded in an insulation, is not only suitable as an electric heater for a λ=1 probe or a broadband lambda probe. It may also be applied as a temperature sensor, such as for measuring the temperature of the exhaust gas of internal combustion engines. In this case a cover layer is additionally printed onto upper insulating layer 22, which may be made of the same material as first solid electrolyte layer 11. Alternatively, one may do without this cover layer, and upper insulating layer 22 may be sintered in a gas-tight manner.

In one modification of the laminate, in which resistor track 20 and lead tracks 24, 25 are made of platinum and solid electrolyte layers 11, 12 are made of a zirconium oxide in which only a fraction of the current flows in the platinum, one may do without the embedding of lead tracks 24, 25 in an electrical insulation.

1-19. (canceled)

20. A ceramic laminate, comprising:
at least one solid electrolyte layer;
at least one insulation layer provided on the at least one solid electrolyte layer;
an electrical resistor track extending in a meandering configuration and connected to two electrical lead tracks, wherein the electrical resistor track and the two electrical lead tracks are embedded in the at least one insulation layer, and wherein the resistor track includes a material having a greater specific Ohmic resistance compared to a material of the two lead tracks, and wherein the resistor track has a width that is maximum possible width defined as a function of a width of the at least one insulation layer, and wherein the resistor track has a thickness that is at least an order of magnitude smaller than the width of the resistor track.

21. The laminate as recited in claim 20, wherein the specific Ohmic resistance of the material of the resistor track is at least twice as great as the specific Ohmic resistance of the material of the two lead tracks.

22. The laminate as recited in claim 21, wherein a temperature coefficient of the material of the resistor track is less than a temperature coefficient of the material of the two lead tracks.

23. The laminate as recited in claim 22, wherein the width of the resistor track is greater than the width of each of the two lead tracks.

24. The laminate as recited in claim 23, wherein the width of the resistor track is at least 50% greater than the width of each of the two lead tracks.

25. The laminate as recited in claim 22, wherein the width of the resistor track is dimensioned greater than 500 μm.

26. The laminate as recited in claim 22, wherein the thickness of the resistor track is less than 14 μm.

27. The laminate as recited in claim 20, wherein the resistor track includes a high Ohmic platinum paste.

28. The laminate as recited in claim 27, wherein the high Ohmic platinum paste has an aluminum oxide support content of approximately 30%.

29. The laminate as recited in claim 27, wherein the thickness of the resistor track is at least 5 μm.

30. The laminate as recited in claim 27, wherein the high Ohmic platinum paste contains nanoplatinum and the thickness of the resistor track is dimensioned at less than 5 μm.

31. The laminate as recited in claim 22, wherein the resistor track has three meandering turns resulting in four meander legs which extend parallel to one another, and wherein two interior meander legs are locally widened in width.

32. The laminate as recited in claim 22, wherein the two lead tracks include low Ohmic platinum paste.

33. The laminate as recited in claim 32, wherein the low Ohmic platinum paste has an aluminum oxide support content of approximately 5%.

34. The laminate as recited in claim 22, wherein the thickness of resistor track and the thickness of the two lead tracks are substantially equal.

35. The laminate as recited in claim 22, wherein the at least one insulation layer includes a first insulating layer and a second insulating layer, the first insulating layer being applied onto the solid electrolyte layer, and wherein the resistor track is situated on the first insulating layer, and wherein that second insulating layer covers the resistor track.

36. The laminate as recited in claim 35, wherein the first insulating layer coats the at least one solid electrolyte layer, the resistor track and the two lead tracks are printed onto the first insulating layer, and the second insulating layer covers the resistor track and the two lead tracks.

37. The laminate as recited in claim 22, wherein the laminate is configured as an electrical heater in a sensor element for measuring an oxygen concentration in an exhaust gas of an internal combustion engine, and wherein the sensor element is connected to a side of the resistor track embedded in the at least one insulation layer and facing away from the at least one solid electrolyte layer.

38. The laminate as recited in claim 22, wherein the laminate is configured as a temperature sensor for measuring a temperature of an exhaust gas of an internal combustion engine.
